(19) United States
(12) Patent Application Publication
(10) Pub. No.: US 2008/0098162 A1
(43) Pub. Date: Apr. 24, 2008

(54) EMBEDDED SYSTEM AND INTERFACE APPARATUS THEREOF AND METHOD OF UPDATING DATA FOR NON-VOLATILE MEMORY

(75) Inventor: Ying-Chih Yang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: SUNPLUS TECHNOLOGY CO., LTD., Hsinchu (TW)

(21) Appl. No.: 11/872,722

(22) Filed: Oct. 16, 2007

(30) Foreign Application Priority Data
Oct. 19, 2006 (TW) 95138532

(51) Int. Cl. G06F 12/02; G06F 13/42

(52) U.S. Cl. 711/103; 710/105; 711/E12.008

(57) ABSTRACT

An interface apparatus and a method of updating data for non-volatile memory are provided. The interface apparatus of the present invention is suitable for an embedded system having a universal-serial-bus (USB) interface and a non-volatile memory. The interface apparatus employs a command translator to directly translate the specific form command commanded by an external device, so that, the interface apparatus may well directly initialize and read/write data from/to the non-volatile memory of the embedded system, without being processed by the microprocessor inside the embedded system.

### CROSS-REFERENCE TO RELATED APPLICATION

This application claims the priority benefit of Taiwan application serial no. 95138532, filed on Oct. 19, 2006. All disclosure of the Taiwan application is incorporated herein by reference.

### BACKGROUND OF THE INVENTION

1. Field of the Invention

The present invention relates to an interface apparatus and an embedded system thereof and a method of updating data for a non-volatile memory, and more particularly, to an interface apparatus capable of directly initializing and reading/writing data from/to the non-volatile memory of the embedded system without being processed by the microprocessor of the embedded system and an embedded system thereof and a method of updating data for a non-volatile memory.

2. Description of Related Art

In an embedded system having a non-volatile memory, the non-volatile memory needs a correct initial value in order to let the user to correctly read/write data from/to the non-volatile memory under the normal operating state of the embedded system. The above mentioned correct initial value is an initial program code written into the non-volatile memory during the mass production process.

Generally, when the non-volatile memory does not have a correct initial program code, there are two methods to deal with reading/writing data from/to the non-volatile memory in order to communicate with the memory control module inside the embedded system. The first method is implemented by using an active communication manner, for example, in-circuit emulation (ICE), and the second method is implemented by using a passive communication manner, for example, serial interface RS-232.

FIG. 1 is a block diagram of an embedded system using an active communication manner to read/write data from/to the non-volatile memory, when the non-volatile memory does not have a correct initial program code. Referring to FIG. 1, the ICE 101 is used to completely control the microprocessor 103 inside the embedded system 100, and a fixed program code is provided by a memory control module 105 (i.e., the initial program code required by the non-volatile memory) for being processed by the microprocessor 103. After the data is transmitted through a bus 107 to a non-volatile memory controller 109 for being converted, the user begins to perform read/write data from/to the non-volatile memory 111.

FIG. 2 is a block diagram of an embedded system using a passive communication manner to read/write data from/to the non-volatile memory, when the non-volatile memory does not have a correct initial program code. Referring to FIG. 2, user must write and store an initial program code in the memory control module 207 through an external PC host 211 and the serial interface 213 (i.e. RS-232). After the initial program code is performed by the microprocessor 209, the user begins to perform read/write data from/to the non-volatile memory 201.

However, it should be noted that, not all of the embedded systems have the ICE, so if the user intends to use the ICE in the first method, it is necessary to extend the ICE and the ICE interface (i.e., a hardware control module of the ICE) inside the embedded system. In terms of certain design concepts, it does not meet the design cost requirement. In addition, if the user intends to use the second method, after the microprocessor inside the embedded system executes the initial program code, the user begins to perform read/write data from/to the non-volatile memory. However, during the process of the mass production of the non-volatile memory, if the data is not yet written into the non-volatile memory on the board during the mass production process, the expected effect cannot be achieved by using the second method.

### SUMMARY OF THE INVENTION

In view of the above, the present invention is directed to provide an interface apparatus and the embedded system using the same. A command translator is extended into the embedded system having a USB interface, so as to directly initialize and read/write data from/to the non-volatile memory of the embedded system, without being processed by the microprocessor inside the embedded system.

The present invention is also directed to provide a method of updating data for the non-volatile memory, wherein after the specific form command commanded by the external device is directly translated; the initialization or read/write data is performed from/to the non-volatile memory accordingly.

Based on the above and other objectives, the interface apparatus provided by the present invention is suitable for the embedded system having a non-volatile memory. The interface apparatus of the present invention comprises a USB device/PHY, a command translator and a bus master. The USB device/PHY is used to receive a USB timing signal provided by an external device, and convert the USB timing signal to generate a specific form command. The command translator is used to directly translate the specific form command outputted by the USB device/PHY, and generate an operating signal accordingly. The bus master is used to perform initialization or read/write data from/to the non-volatile memory of the embedded system through the bus according to the operating signal outputted by the command translator.

According to another aspect of the present invention, an embedded system is provided, which comprises a non-volatile memory and an interface apparatus, wherein the interface apparatus is used to directly translate the specific form command commanded by the external device and initialize or read/write data from/to the non-volatile memory accordingly.

In an embodiment of the present invention, the interface apparatus of the embedded system comprises a USB device/PHY, a command translator and a bus master. The USB device/PHY is used to receive the USB timing signal provided by the external device and convert the USB timing signal to generate a specific form command. The command translator is used to directly translate the specific form command outputted by the USB device/PHY and generate an operating signal accordingly. The bus master is used to perform initialization or read/write data from/to the non-volatile memory through the bus according to the operating signal outputted by the command translator.

According to another aspect of the present invention, a method of updating data for the non-volatile memory is provided, which is suitable for the embedded system having the USB function, and the method comprises the following steps. First, (a) the specific form command from the external device is received; and then (b) the specific form command is directly translated to perform initialization or read/write data from/to the non-volatile memory accordingly.

In an embodiment of the present invention, the step (a) further comprises a step of converting the USB timing signal provided by the external device to generate the specific form command.

In an embodiment of the present invention, the step (b) further comprises: generating an operating signal according to the specific form command; and performing initialization or read/write data from/to the non-volatile memory according to the operating signal.

The interface apparatus provided by the present invention is suitable for the embedded system having the USB interface and the non-volatile memory. The interface apparatus employs the command translator to directly translate the specific form command commanded the external device that has been converted by the USB device/PHY, so that the initialization or read/write data is directly performed from/to the non-volatile memory of the embedded system, without being processed by the microprocessor inside the embedded system. In addition, in the method of updating data for the non-volatile memory provided by the present invention, after the specific form command commanded by the external device is directly translated, the initialization or read/write data is performed from/to the non-volatile memory accordingly; thereby directly updating data for the non-volatile memory is achieved.

In order to make aforementioned and other objects, features and advantages of the present invention comprehensible, preferred embodiments accompanied with figures are described in detail below.

### BRIEF DESCRIPTION OF THE DRAWINGS

FIG. 1 is a block diagram of an embedded system using an active communication manner to data read/write data from/to the non-volatile memory, when the non-volatile memory does not have a correct initial program code.

FIG. 2 is a block diagram of an embedded system using a passive communication manner to read/write data from/to the non-volatile memory, when the non-volatile memory does not have a correct initial program code.

FIG. 3 is a block diagram of an embedded system according to a preferred embodiment of the present invention.

FIG. 4 shows a method of updating data for the non-volatile memory according to a preferred embodiment of the present invention.

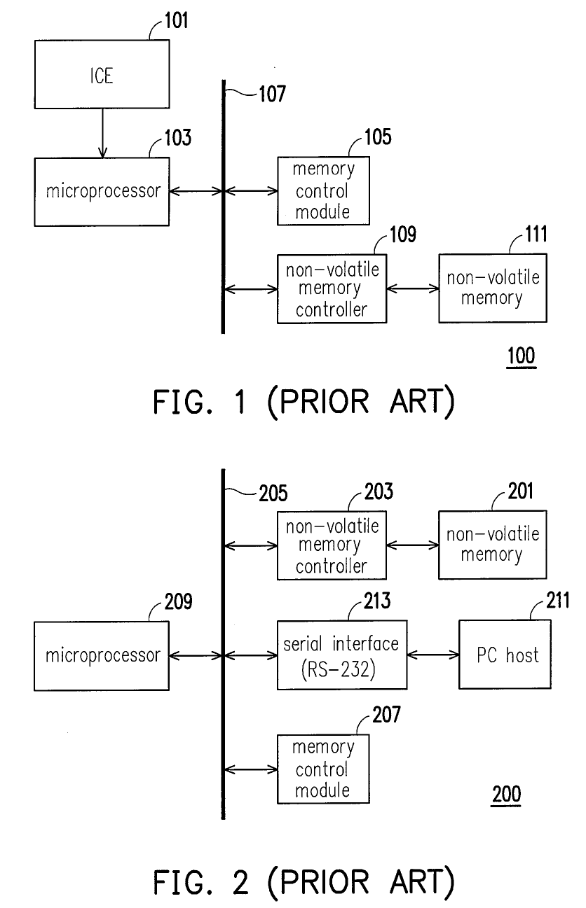

### DESCRIPTION OF EMBODIMENTS

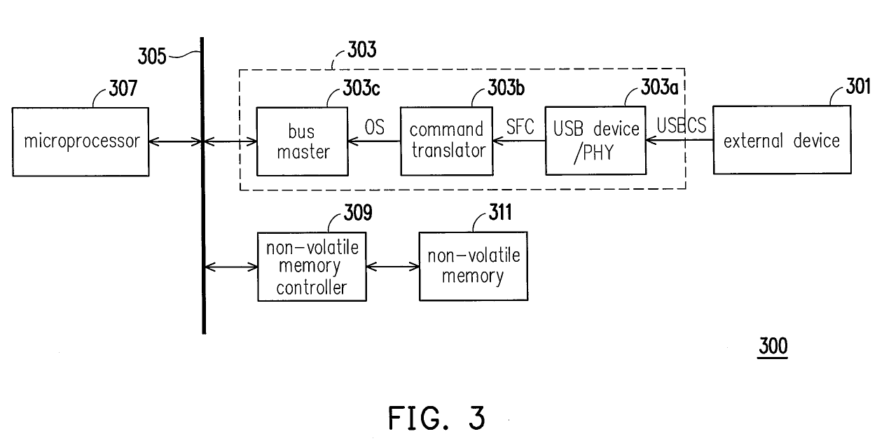

FIG. 3 is a block diagram of an embedded system 300 according to a preferred embodiment of the present invention. Referring to FIG. 3, the embedded system 300 includes an external device 301, an interface apparatus 303, a bus 305, a microprocessor 307, a non-volatile memory controller 309 and a non-volatile memory 311. The interface apparatus 303 includes a USB device/PHY 303a, a command translator 303b and a bus master 303c.

In this embodiment, the external device 301 is, for example, a PC host or a USB controller, and the non-volatile memory 311 is, for example, a flash memory, so that the non-volatile memory controller 309 is a flash memory controller. However, the present invention is not limited thereto as such. The user may also use different non-volatile memories according to the practical requirements.

In this embodiment, after the USB device/PHY 303a of the interface apparatus 303 receives the USB timing signal USBCS provided by the external device 301, it converts the USB timing signal USBCS and then outputs a specific form command SFC. Next, the command translator 303b translates the specific form command SFC and generates an operating signal OS accordingly. Then, according to the operating signal OS, the bus master 303c controls the operations of the bus 305, and provides the signal content through the bus 305 to the non-volatile memory 309 for being converted, thereby initializing or reading/writing data from/to the non-volatile memory 311.

As know from the above that, during the operation, the interface apparatus 303 of this embodiment directly initializes or reads/writes data from/to the non-volatile memory 311, without being processed by the microprocessor 307. Particularly, the command translator 303b inside the interface apparatus 303 replaces the microprocessor 307 to perform the original tasks of the microprocessor 307. Therefore, in this embodiment, the external device 301 commands the command (i.e., the specific form command SFC) through the USB device/PHY 303 a to the command translator 303b for being translated. Then, accordingly, the bus master 303c is used to control the bus 305, and the non-volatile memory controller 309 is directly controlled, so as to initialize or read/write data from/to the non-volatile memory 311.

In addition, it should be noted that, after the interface apparatus 303 has completed the operations, the embedded system 300 returns to the normal operating mode, i.e., the microprocessor 307 continuously to manage the whole operating mode of the embedded system 300, and at this time, the USB device/PHY 303a is responsible for accessing other USB controllers or USB devices.

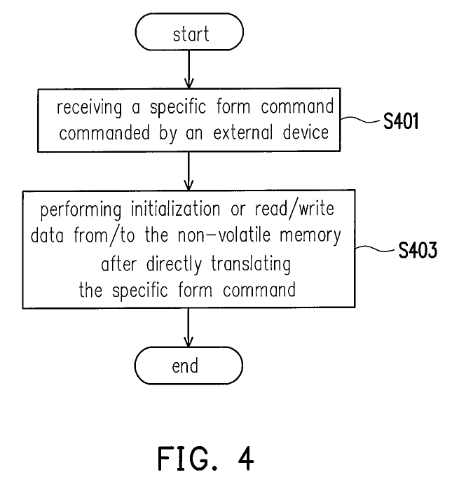

FIG. 4 shows a method of updating data for the non-volatile memory according to a preferred embodiment of the present invention. Referring to FIG. 4, the method of updating data for the non-volatile memory (e.g., flash memory) of this embodiment is suitable for the embedded system having the USB function, which includes the following steps. First, in Step S401, the specific form command commanded by the external device (e.g., PC host or USB controller) is received, wherein the specific form command is generated by converting the USB timing signal provided by the external device.

Next, in Step S403, the specific form command is directly translated, and then, the initialization or read/write data is performed from/to the non-volatile memory accordingly. In this step, after the specific form command is translated, an operating signal is generated, which is used to initialize or read/write data from/to the non-volatile memory.

In this embodiment, when Step S403 is completed, i.e., the initialization or read/write data has been performed from/to the non/volatile memory; the microprocessor inside the embedded system continuously to manage the whole operating mode of the embedded system.

To sum up, the present invention provides an interface apparatus, which is suitable for the embedded system having the USB interface and the non-volatile memory. In the interface apparatus of the present invention, the command translator is used to translate the command commanded by the external device, so that the initialization or read/write data is directly performed from/to the non-volatile memory, without being processed by the microprocessor inside the embedded system, thereby solving the technical bottleneck of the prior art. In addition, in the method of updating data for the non-volatile memory provided by the present invention, after the specific form command commanded by the external device is directly translated, the initialization or read/write data is directly performed from/to the non-volatile memory accordingly, thereby directly updating data for the non-volatile memory.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An interface apparatus, suitable for an embedded system having a non-volatile memory, comprising:
an universal-serial-bus (USB) device/physical layer (PHY), for receiving a USB timing signal provided by an external device, and converting the USB timing signal to generate a specific form command;
a command translator, coupled to the USB device/PHY, for directly translating the specific form command, and generating an operating signal accordingly; and
a bus master, coupled to the command translator, for initializing or reading/writing data from/to the non-volatile memory through a bus according to the operating signal.

2. The interface apparatus as claimed in claim 1, further comprising a non-volatile memory controller, coupled between the bus and the non-volatile memory, for converting data on the bus, and initializing or reading/writing the data from/to the non-volatile memory accordingly.

3. The interface apparatus as claimed in claim 1, wherein the external device is a PC host or a USB controller.

4. The interface apparatus as claimed in claim 1, wherein the non-volatile memory is a flash memory.

5. An embedded system, comprising:
a non-volatile memory; and
an interface apparatus, coupled to the non-volatile memory, for directly translating a specific form command commanded by an external device, and performing the initialization or read/write data from/to the non-volatile memory accordingly.

6. The embedded system as claimed in claim 5, wherein the interface apparatus comprises:
a USB device/PHY, for receiving a USB timing signal provided by the external device, and converting the USB timing signal;
a command translator, coupled to the USB device/PHY, for directly translating the specific form command, and generating an operating signal accordingly; and
a bus master, coupled to the command translator, for initializing or reading/writing data from/to the non-volatile memory through a bus according to the operating signal.

7. The embedded system as claimed in claim 6, wherein the interface apparatus further comprises a non-volatile memory controller, coupled between the bus and the non-volatile memory, for converting data on the bus, and initializing or reading/writing the data from/to the non-volatile memory accordingly.

8. The embedded system as claimed in claim 5, further comprising a microprocessor, for continuously managing the embedded system after the operation of interface apparatus has completed.

9. The embedded system as claimed in claim 5, wherein the external device is a PC host or a USB controller.

10. The embedded system as claimed in claim 5, wherein the non-volatile memory is a flash memory.

11. A method of updating data for the non-volatile memory, suitable for an embedded system having the USB function, comprising steps of:
(a) receiving a specific form command commanded by an external device; and
(b) performing initialization or read/write data from/to the non-volatile memory after directly translating the specific form command.

12. The method of updating data for the non-volatile memory as claimed in claim 11, wherein the step (a) further comprises a step of converting a USB timing signal provided by the external device to generate the specific form command.

13. The method of updating data for the non-volatile memory as claimed in claim 11, wherein the step (b) further comprises:
generating an operating signal according to the specific form command; and
performing initialization or read/write data from/to the non-volatile memory according to the operating signal.

14. The method of updating data for the non-volatile memory as claimed in claim 11, wherein a microprocessor inside the embedded system continuously manages the whole operating mode of the embedded system after the step (b) has performed completely.

15. The method of updating data for the non-volatile memory as claimed in claim 11, wherein the external device is a PC host or a USB controller.

16. The method of updating data for the non-volatile memory as claimed in claim 11, wherein the non-volatile memory is a flash memory.
